(19) United States
(12) Patent Application Publication
(10) Pub. No.: US 2014/0157793 A1
(43) Pub. Date: Jun. 12, 2014

(54) NOVEL MAGNETIC REFRIGERANT MATERIALS

(71) Applicant: GENERAL ELECTRIC COMPANY, Schenectady, NY (US)

(72) Inventors: Francis Johnson, Clifton Park, NY (US); Min Zou, Niskayuna, NY (US); Ming Yin, Rexford, NY (US); Raghavendra Rao Adharapurapu, Schenectady, NY (US); Christopher Klapper, Glenville, NY (US); Vijay Kumar Srivastava, Schenectady, NY (US)

(73) Assignee: GENERAL ELECTRIC COMPANY, Schenectady, NY (US)

(21) Appl. No.: 13/707,756

(22) Filed: Dec. 7, 2012

(51) Int. Cl. C09K 5/00; F25B 21/00

(52) U.S. Cl. CPC C09K 5/00; F25B 21/00
USPC 62/3.1; 252/67

(57) ABSTRACT

A novel magneto caloric material (MCM) is provided that can be used in, for example, a regenerator of a heat pump, appliance, air conditioning system, and other heating and/or cooling devices. The MCM is a type of Heusler alloy, has an L2₁ crystal structural prototype, and can undergo a reversible phase transformation between a low temperature, low magnetization Martensite phase and a high temperature, high magnetization Austenite phase to exhibit an inverse magneto caloric effect upon application of a sufficient magnetic field. A process of annealing of the alloy is also provided that can be used to adjust the temperature at which this phase transformation occurs. The present invention includes the alloy as subjected to such annealing.

### FIELD OF THE INVENTION

The subject matter of the present disclosure relates generally to magnetic refrigerant materials also referred to as magneto caloric materials.

### BACKGROUND OF THE INVENTION

Conventional refrigeration technology typically utilizes a heat pump that relies on compression and expansion of a fluid refrigerant to receive and reject heat in a cyclic manner so as to effect a desired temperature change or i.e. transfer heat energy from one location to another. This cycle can be used to provide e.g., for the receiving of heat from a refrigeration compartment and the rejecting of such heat to the environment or a location that is external to the compartment. Other applications include air conditioning of residential or commercial structures. A variety of different fluid refrigerants have been developed that can be used with the heat pump in such systems.

While improvements have been made to such heat pump systems that rely on the compression of fluid refrigerant, at best such can still only operate at about 45 percent or less of the maximum theoretical Carnot cycle efficiency. Also, some fluid refrigerants have been discontinued due to environmental concerns. The range of ambient temperatures over which certain refrigerant-based systems can operate may be impractical for certain locations. Other challenges with heat pumps that use a fluid refrigerant exist as well.

Magneto caloric materials (MCMs)—i.e. materials that exhibit the magneto caloric effect—provide a potential alternative to fluid refrigerants for heat pump applications. In general, the magneto caloric effect refers to a process of entropic change whereby the magnetic moments of an MCM will change under application of an externally applied magnetic field and cause the MCM to either heat or cool under adiabatic conditions. For example, for some MCMs, magnetic moments of an MCM will become more ordered under an increasing, externally applied magnetic field and cause the MCM to generate heat. Conversely, decreasing the externally applied magnetic field will allow the magnetic moments of the MCM to become more disordered and allow the MCM to absorb heat. Some MCMs exhibit the opposite behavior—i.e. generating heat when the magnetic field is removed (which are sometimes referred to as exhibiting the “inverse magneto caloric effect”—but both types are referred to collectively herein as magneto caloric material or MCM unless otherwise specified). The theoretical Carnot cycle efficiency of a refrigeration cycle based on an MCM can be significantly higher than for a comparable refrigeration cycle based on a fluid refrigerant. As such, a heat pump system that can effectively use an MCM would be useful.

Challenges exist to the practical and cost competitive use of an MCM, however. For example, the ambient conditions under which a heat pump may be needed can vary substantially. For a refrigerator appliance placed in a garage or located in a non-air conditioned space, ambient temperatures can range from below freezing to over 90° F. Some MCMs are capable of experiencing the magneto caloric effect (and thereby accepting and generating heat) only within a much narrower temperature range than required by such ambient conditions. Still other MCMs may only exhibit the magneto caloric effect at temperatures that are not useful for refrigeration, air-conditioning, and/or other applications where heating and/or cooling is needed.

Also, the amount of entropy change (which can determine the amount of heat generated or received) by an MCM due to interaction with a magnetic field is not the same per unit mass of material for every MCM. It is desirable to for the entropy change due to a change in magnetic field to be relatively high per unit of mass so as to minimize the amount of MCM that must be used in a given heat pump system as the material costs for an MCM can be substantial.

Accordingly, an MCM that can be used as a magnetic refrigerant in a heat pump system would be useful. More particularly, an MCM that can be used as a magnetic refrigerant in regenerators for refrigeration systems, air conditioning systems, and/or other applications where heating, cooling, or both are needed would be beneficial. A process for modifying an MCM so as to change the temperature at which the material exhibits the magneto caloric effect (referred to herein as the “magnetostructural phase transition temperature” or “MPTT”) would also be useful.

### BRIEF DESCRIPTION OF THE INVENTION

The present invention provides a novel magneto caloric material (MCM) that can be used in, for example, a regenerator of a heat pump, appliance, air conditioning system, and other heating and/or cooling devices. The MCM is a type of Heusler alloy, has an L2₁ crystal structural prototype, and can undergo a reversible phase transformation between a low temperature, low magnetization Martensite phase and a high temperature, high magnetization Austenite phase to exhibit an inverse magneto caloric effect upon application or removal of a sufficient magnetic field. Annealing of the alloy can be used to adjust the temperature at which this phase transformation—and thus the inverse magneto caloric effect—occurs. Such adjustability provides added versatility in that the same alloy may be used over a wider temperature range for cooling and heating applications. The present invention includes the alloy as subjected to such annealing as well as the method of annealing the alloy to adjust, alter, or tune the temperature at which the transition between Martensite and Austenite occurs—which for this alloy also corresponds to the temperature at which the magneto-structural phase transition occurs or MPTT. Additional aspects and advantages of the invention will be set forth in part in the following description, or may be apparent from the description, or may be learned through practice of the invention.

In one exemplary embodiment, the present invention provides a magnetic refrigerant that includes a magnetocaloric alloy material having a composition according to the formula:

A_{w}BₓC_{y}D_{z}

where:

A is Ni, Co, Cr, or a combination thereof, and 40%≦w≦56%,

B is Mn and 15%≦x≦45%,

C is In, Ga, Sn, Sb, Cu, or a combination thereof, and 9%≦y≦30%,

D is Si, Ge, As, or a combination thereof, and 0%≦z≦5%; and

w+x+y+z=100% (all in atomic percent).

In another exemplary embodiment, the present invention provides a refrigerator appliance that includes a compartment for the storage of food items; a first heat exchanger for the removal of heat from the compartment; a second heat exchanger for the delivery of heat removed by the first heat exchanger to a location external of the compartment; and a regenerator in thermal communication the first and second heat exchanger and configured for the transfer of heat between the first and second heat exchanger. The regenerator has a magnetic refrigerant that includes a magnetocaloric alloy material having a composition according to the formula:

A_{w}BₓC_{y}D_{z}

where:

A is Ni, Co, Cr, or a combination thereof, and 40%≦w≦56%,

B is Mn and 15%≦x≦45%,

C is In, Ga, Sn, Sb, Cu, or a combination thereof, and 9%≦y≦30%,

D is Si, Ge, As, or a combination thereof, and 0%≦z≦5%; and

w+x+y+z=100%.

In still another exemplary embodiment, the present invention provides a magnetic refrigerant having a magnetocaloric alloy material prepared by a process that includes the steps of preparing an alloy material having a composition according to the formula:

A_{w}BₓC_{y}D_{z}

where:

A is Ni, Co, Cr, or a combination thereof, and 40%≦w≦56%,

B is Mn and 15%≦x≦45%,

C is In, Ga, Sn, Sb, Cu, or a combination thereof, and 9%≦y≦30%,

D is Si, Ge, As, or a combination thereof, and 0%≦z≦5%; and

w+x+y+z=100%;

annealing the alloy in a first annealing step at a temperature in the range of about 800° C. to about 1000° C. for a first predetermined period of time; quenching the alloy in a first quenching step; annealing the alloy in a second annealing step at a temperature in the range of about 500° C. to about 700° C. for a second predetermined period of time; and quenching the alloy in a second quenching step.

In still another exemplary embodiment, the present invention provides a method of preparing a magnetocaloric alloy material that includes the steps of preparing an alloy material having a composition according to the formula:

A_{w}BₓC_{y}D_{z}

where:

A is Ni, Co, Cr, or a combination thereof, and 40%≦w≦56%,

B is Mn and 15%≦x≦45%,

C is In, Ga, Sn, Sb, Cu, or a combination thereof, and 9%≦y≦30%,

D is Si, Ge, As, or a combination thereof, and 0%≦z≦5%; and

w+x+y+z=100%;

annealing the alloy in a first annealing step at a temperature in the range of about 800° C. to about 1000° C. for a first predetermined period of time; quenching the alloy in a first quenching step; annealing the alloy in a second annealing step at a temperature in the range of about 500° C. to about 700° C. for a second predetermined period of time; and quenching the alloy in a second quenching step.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides an exemplary embodiment of a refrigerator appliance of the present invention.

FIG. 2 is a schematic illustration of an exemplary heat pump system of the present invention positioned in an exemplary refrigerator with a machinery compartment and a refrigerated compartment.

FIG. 3 is a schematic representation of various steps in the use of a regenerator as could be present within the heat pump shown in FIG. 2.

FIGS. 4, 5, and 6 are plots of Martensite transition temperature—i.e. the MPTT—as a function of annealing as further described below.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

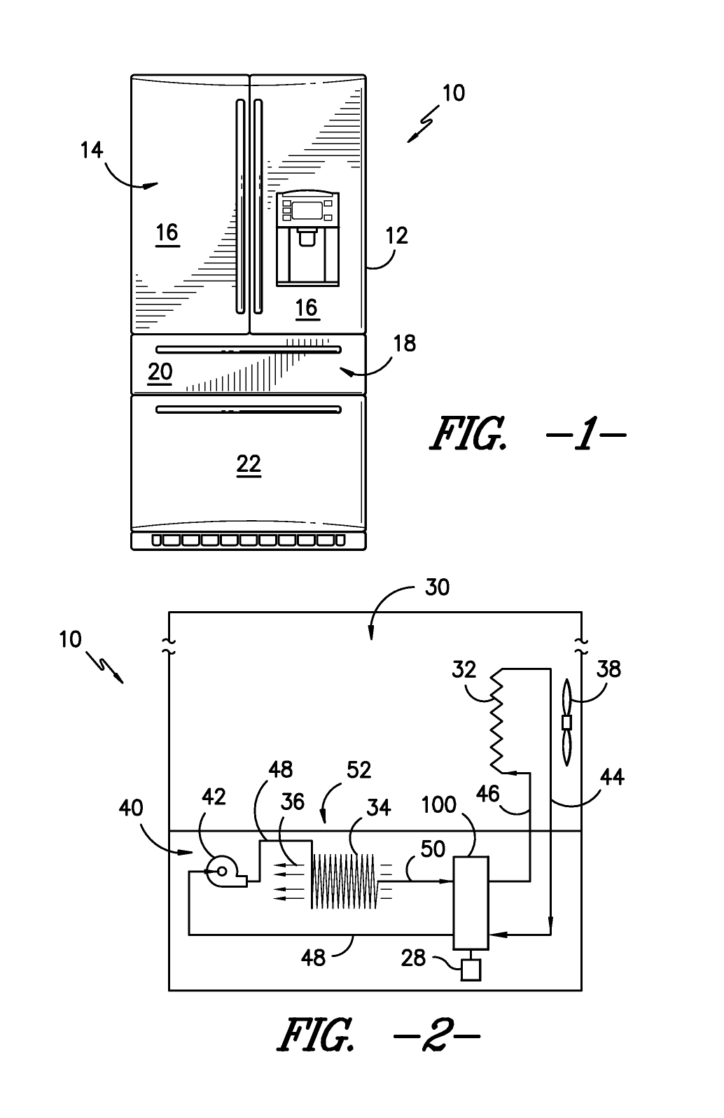

Referring now to FIG. 1, an exemplary embodiment of an appliance refrigerator 10 as may be used with an alloy of the present invention is depicted. Upright refrigerator 10 has a cabinet or casing 12 that defines a number of internal storage compartments or chilled chambers. In particular, refrigerator appliance 10 includes upper fresh-food compartments 14 having doors 16 and lower freezer compartment 18 having upper drawer 20 and lower drawer 22. The drawers 20, 22 are “pull-out” type drawers in that they can be manually moved into and out of the freezer compartment 18 on suitable slide mechanisms.

Refrigerator 10 is provided by way of example only. Other configurations for a refrigerator appliance may be used with the present invention as well including appliances with only freezer compartments, only chilled compartments, or other combinations thereof different from that shown in FIG. 1. In addition, the alloy of the present invention is not limited to use with appliances and may be used in other applications as well such as e.g., air-conditioning, electronics cooling devices, and others. Thus, it should be understood that while the use of a regenerator within a refrigerator is provided by way of example herein, the alloy of the present invention may also be used to provide for both heating and cooling applications.

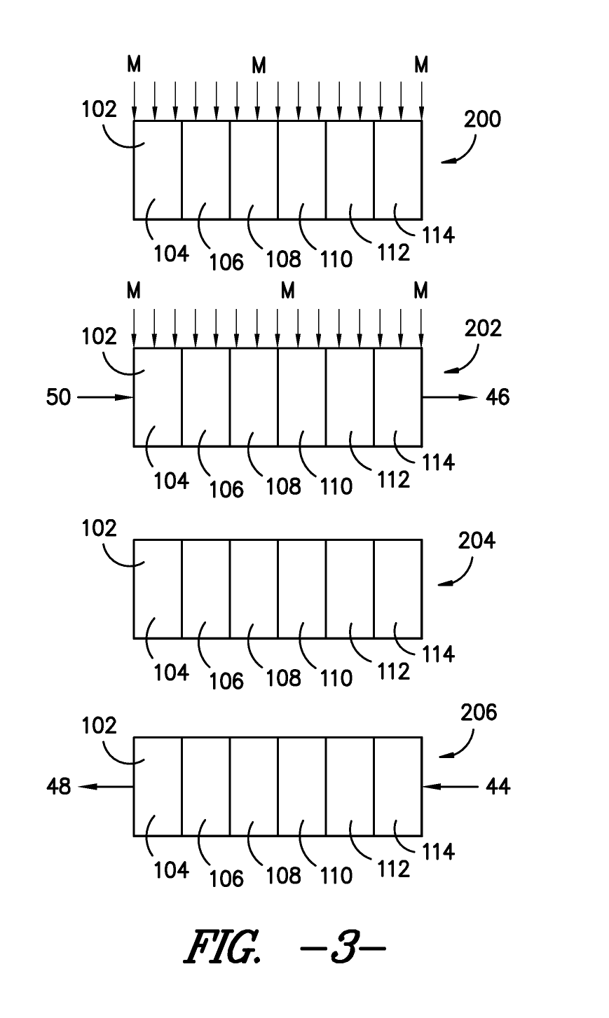

FIG. 2 is a schematic view of another exemplary embodiment of a refrigerator appliance 10 including a refrigeration compartment 30 and a machinery compartment 40. In particular, machinery compartment 30 includes a heat pump system 52 having a first heat exchanger 32 positioned in the refrigeration compartment 30 for the removal of heat therefrom. A heat transfer fluid such as e.g., an aqueous solution, flowing within first heat exchanger 32 receives heat from the refrigeration compartment 30 thereby cooling its contents. A fan 38 may be used to provide for a flow of air across first heat exchanger 32 to improve the rate of heat transfer from the refrigeration compartment 30.

The heat transfer fluid flows out of first heat exchanger 32 by line 44 to heat pump 100. As will be further described herein, the heat transfer fluid receives additional heat from the alloy of the present invention—a magneto caloric material (MCM) located in heat pump 100—and carries this heat by line 48 to pump 42 and then to second heat exchanger 34. Heat is released to the environment, machinery compartment 40, and/or other location external to refrigeration compartment 30 using second heat exchanger 34. A fan 36 may be used to create a flow of air across second heat exchanger 34 and thereby improve the rate of heat transfer to the environment. Pump 42 connected into line 48 causes the heat transfer fluid to recirculate in heat pump system 52. Motor 28 is in mechanical communication with heat pump 100 as will further described.

From second heat exchanger 34, the heat transfer fluid returns by line 50 to heat pump 100 where, as will be further described below, the heat transfer fluid loses heat to the MCM in heat pump 100. The now colder heat transfer fluid flows by line 46 to first heat exchanger 32 to receive heat from refrigeration compartment 30 and repeat the cycle as just described.

Heat pump system 52 is provided by way of example only. Other configurations of heat pump system 52 may be used with the alloy of the present invention serving as a magnetic refrigerant. For example, lines 44, 46, 48, and 50 provide fluid communication between the various components of the heat pump system 52 but other heat transfer fluid recirculation loops with different lines and connections may also be employed. For example, pump 42 can also be positioned at other locations or on other lines in system 52. A heat pump or heat pump system that does not utilize a heat transfer fluid may also be used. In such case, for example, heat pump 100 would be in thermal communication with first and second heat exchangers 32 and 34 by something mechanism. Still other configurations of heat pump system 52 may be used with the alloy/MCM of the present invention as well. Additionally, the alloy of the present invention may also be used in other heating and/or cooling applications that may not utilize a heat pump or an appliance.

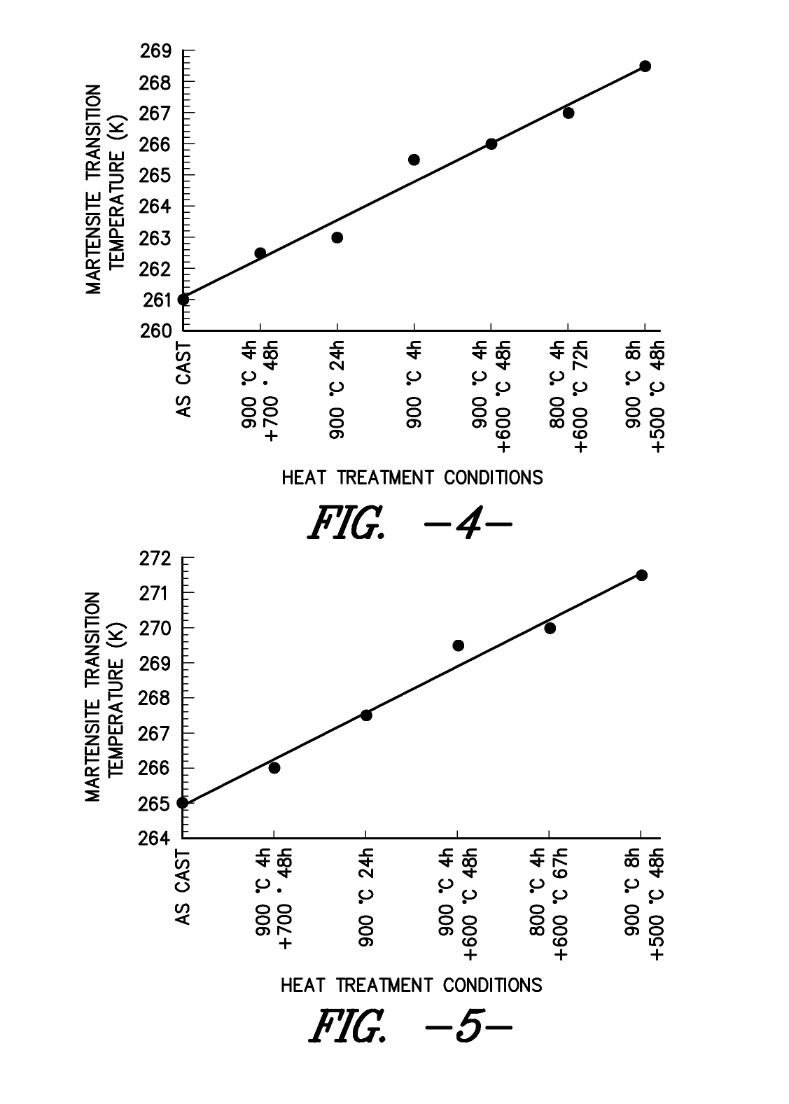

FIG. 3 illustrates an exemplary method of the present invention using a schematic representation of a regenerator 102 as may be used in heat pump 100 of heat pump system 52. Regenerator 102 contains an alloy of the present invention configured in stages 104, 106, 108, 110, 112, and 114 as will be further described. Other configurations of a regenerator using an alloy of the present invention may be used as well including e.g., regenerators having a different number of stages that what is shown.

During step 200, stage 102 containing an alloy of the present invention is positioned fully within a magnetic field M, which induces an inverse magneto caloric effect. More particularly, the presence of the magnetic field causes a transformation between a Martensite phase and an Austenite phase at the MPTT so that the alloy material of zones 104 through 114 decreases in temperature. This decrease in temperature can be used for cooling.

Using heat transfer system 52 by way of example, in step 202, heat transfer fluid from second heat exchanger 34 in line 50 is passed through stage 102. After losing heat to the alloy in stage 102, the heat transfer fluid leaves stage 102 by line 46 and at a lower temperature than when it entered. This cooler heat transfer fluid can now receive heat through first heat exchanger 32.

In step 204, magnetic field M is removed or decreased. This absence or lessening of magnetic field M results in an increase in entropy as another phase transformation between Austenite and Martensite is induced so that the alloy material of zones 104 through 114 now heats up or increases in temperature.

Referring to step 206 of FIG. 3, heat transfer fluid returning from first heat exchanger 32 in line 44 is passed through stage 102 where it receives heat from the alloy. The heat transfer fluid leaves stage 102 by line 48 and at a higher temperature than when it entered. This warmer heat transfer fluid can now reject heat to the environment through second heat exchanger 34 and then the heat transfer cycle can be repeated.

As stated, stage 102 includes an alloy positioned as adjacent zones of material along the axial direction of flow of the heat transfer fluid as shown in FIG. 3. Stage 102 may be constructed from a single zone of the alloy or may include multiple different zones of the alloy as illustrated by zones 104 through 114. By way of example, appliance 10 may be used in an application where the ambient temperature changes over a substantial range. As such, it may be necessary to use zones of the alloy where each zone undergoes the inverse magneto caloric effect at different temperatures from an adjacent zone.

Accordingly, as shown in FIG. 3, stage 102 is provided with zones 104 through 114 of the alloy of the present invention. Each such zone includes a version of the alloy that exhibits the inverse magneto caloric effect at a different temperature or a different temperature range than an adjacent zone along the axial direction of stage 102. For example, zone 152 may exhibit the inverse magneto caloric effect at a MPTT greater than the MPTT at which zone 154 exhibits the inverse magnet caloric effect, which may be greater than the MPTT for zone 156, and so on. Other configurations may be used as well. By configuring the appropriate number sequence of zones of MCM, heat pump 100 can be operated over a substantial range of ambient temperatures. As will be described, the present invention provides a novel alloy for which the MPTT can be tuned to the application desired by annealing. A method of such annealing is also provided.

In one exemplary aspect, the alloy of the present invention is of the L2₁ crystal structural prototype and comprises a magneto caloric material having a composition according to the formula:

A_{w}BₓC_{y}D_{z}

where:

A is Ni, Co, Cr, or a combination thereof, and 40%≦w≦56%,

B is Mn and 15%≦x≦45%,

C is In, Ga, Sn, Sb, Cu, or a combination thereof, and 9%≦y≦30%,

D is Si, Ge, As, or a combination thereof, and 0%≦z≦5%; and

w+x+y+z=100% and all variables are in atomic percent.

In another exemplary aspect, the present invention includes an alloy providing a magneto caloric material having a composition according to the formula above where:

A is Ni, and 45%≦w≦55%,

B is Mn, and 30%≦x≦45%,

C is In, and 9%≦y≦30%; and

D is Si, and 0.1%≦z≦5%.

In still another exemplary aspect, the present invention includes an alloy having such atomic composition ratio where:

A is Ni, and 45%≦w≦55%,

B is Mn, and 30%≦x≦45%, and

C is Ga, Cu, or a combination thereof, and 9%≦y≦30% with Cu being present in an amount of about 5 percent or less.

In still yet another exemplary aspect, the present invention includes an alloy providing a magneto caloric material having a composition according to the formula above where:

A is Ni, Co, Cr or a combination thereof, and 45%≦w≦55%,

B is Mn, and 30%≦x≦45%, and

C is In, and 9%≦y≦15% with Cu present in an amount of about 10 percent or less, and Cr present in an amount of 10 percent or less.

As used herein, atomic percent means the percentage of atoms of one element relative to the total number of atoms of all elements present in the alloy.

The inventors have determined that an alloy having the general formula as set forth in the examples above can be used as a magnetic refrigerant with MPTTs in the range of about 220 K to about 340 K depending upon, for example, the particular alloy selected within the formula set for the above. The alloy can be used, for example, in refrigerator appliances needing an alloy having a MPTT in the range of about 250 K to about 316 K.

The alloy can also exhibit magnetocaloric entropy changes (AS) from about zero to about 30 J/kgK with applied magnetic field changes from about 0 to about 5 Tesla. Such alloy can display adiabatic temperature changes (AT) from about zero ° C. to about 8° C. with applied magnetic field changes from about 0 to about 5 Tesla. In one exemplary aspect, the alloy is annealed to minimize hysteresis and to have a volume fraction of greater than, or equal to, about 80 percent in the preferred magneto caloric phase. Also, using the annealing process described herein, the MPTT of the inventive alloy can be altered (i.e., increased) by an amount in the range of greater than 0 K to about 10 K or, in another embodiment, by an amount in the range of greater than 0 K to about 8 K.

As indicated above, the alloy has composition that falls within a family of materials known as the Heusler alloys. These alloys have crystal structures that have the L2₁ structural prototype. The alloy operates by undergoing a reversible phase transformation between a low temperature paramagnetic Martensite phase and a high temperature ferromagnetic austenite phase. The entropy change accompanying the transition is enhanced by coupling a change in magnetic order with the change in configurational order during a crystallographic phase transition. The phase transition can be driven by a change in temperature, magnetic field, stress, or some combination of the three. As the change in magnetization with increasing temperature is positive, the change in entropy with increasing temperature is negative, and hence the alloy of the present invention exhibits what is known as an inverse magnetocaloric effect.

The magnetocaloric performance of the alloy was unexpectedly found to be sensitively dependent on the precise thermal and magnetic field history experienced by the material. More precisely, the amount of the magnetocaloric effect (AS) lost due to hysteresis was reduced by up to two-thirds if the material was cooled, under zero magnetic field, to a temperature no lower than the Martensite start temperature. It was also determined that by annealing, the Martensite transition temperature (corresponding to the MPTT for this material) of the alloy could be adjusted or modified.

For example, in one exemplary method of the present invention, a method of preparing a magnetocaloric alloy material is provided as well as an alloy provided by such method. First, an alloy is prepared having the atomic composition ratio of as set forth in any of the examples above for A_{w}BₓC_{y}D_{z}. For example, a mixture of the raw materials may be melted together in a vacuum or inert atmosphere. One or more remelting and cooling steps may be used. The melted material may be cast as an ingot. The ingot can be converted into a powder by e.g., grinding or milling. By way of example, the material may be subjected to the following annealing steps either before or after conversion in to a powder.

The alloy is then annealed in a first annealing step at a temperature in the range of about 800° C. to about 1000° C. for a first predetermined period of time. By way of example, the first predetermined period of time may be in the range of about 4 hours to about 24 hours. Alternatively, the first annealing step may be at a temperature in the range of about 800° C. to about 900° C.

Next, the alloy is quenched in a first quenching step. For example, the alloy may be immersed in water, oil, or an inert gas at a temperature of less than about 100° C. or in water, oil, or gas that is at about room temperature. Another method of rapidly reducing the temperature may also be employed.

The alloy is then annealed again in a second annealing step at a temperature in the range of about 500° C. to about 700° C. for a second predetermined period of time. By way of example, the second predetermined period of time may be in the range of about 24 hours to about 72 hours.

Again, the alloy in then quenched in a second quenching step. For example, the alloy may be immersed in water, oil, or an inert gas at a temperature of less than about 100° C. or in water, oil, or gas that is at about room temperature. Another method of rapidly reducing the temperature may also be employed.

By controlling the temperature and time of the first and second annealing steps, the inventors have determined that the MPTT can be adjusted or modified as illustrated by the examples below. Accordingly, the present invention allows, for example, the ability to obtain multiple different MPTTs using the same alloy. Such can be useful, for example, in providing multiple zones of magneto caloric material within a regenerator or stage of a regenerator as set forth above.

### EXAMPLES

Three Ni₅₀Mn₅₀₋ₓIn_{x-y}Si_{y} alloys of the atomic composition ratios set forth herein were induction-melted in an Ar atmosphere. Two ingots casted in two batches had the same composition of Ni₅₀Mn₃₅In₁₄Si while the third ingot had a composition of Ni₅₁Mn_{33.4}In_{15.6}. Samples machined from the as-cast ingots were then heat treated in a flowing Ar furnace in a two-step process.

In a first step, the samples were annealed at a temperature between about 800° C. to about 900° C. for times between 4 and 24 hours. After the first annealing step, the samples were quenched to room temperature (˜20° C.) in a water bath. In a second step, the samples were annealed at a temperature between about 500° C. and about 700° C. for times between 48 and 72 hours followed by again quenching to room temperature in a water bath.

The Martensite and Austenite transition temperatures were determined based on the magnetization versus temperature data collected with an applied magnetic field of 10 milliTesla by using a Quantum Design Physical Property Measurement System (PPMS) as provided by Quantum Design, Inc. of San Diego, Calif. The magnetocaloric entropy change (ΔS_{M}) change was calculated from magnetic measurements by the method of integrating the appropriate thermodynamic Maxwell relation, described in the reference by McMichael, R.D et al., (J. Mag. Mag. Mat'l., Vol. 111 (1-2), 1992, pp. 29-33). The magnetic data for this method was measured by first heating the sample to a temperature above both the Austenite and Martensite transition temperatures and then cooling at zero applied magnetic field to the first measurement temperature. The magnetization was then measured isothermally while the applied magnetic field was increased to a value of 1.5 Tesla and then decreased back to a value of zero. The next lowest isothermal measurement temperature was then set by again heating the sample to a temperature above both the Austenite and Martensite transition temperatures and then cooling at zero applied magnetic field to the desired temperature. This process was repeated until all temperatures where a Martensite transition temperature is observed had been measured. Any hysteretic effects were subtracted from the calculated magnetocaloric entropy change.

### Example 1

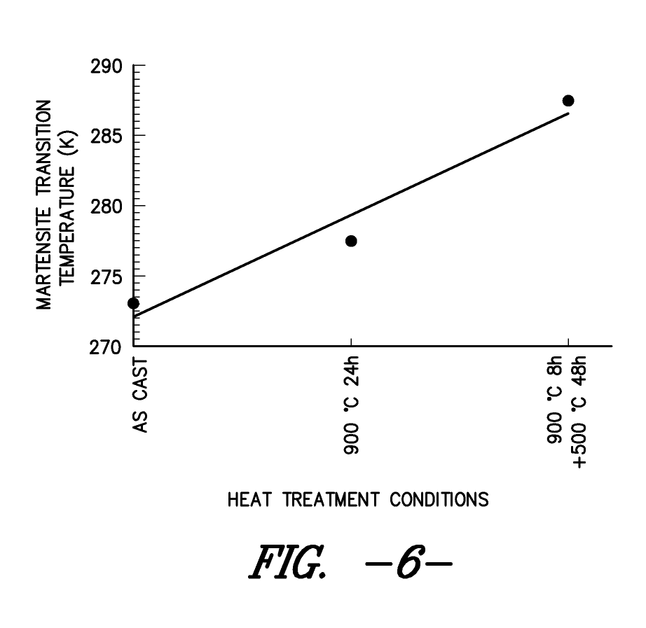

A Ni₅₀Mn₃₅In₁₄Si alloy (Ni₅₀Mn₃₅In₁₄Si-sample PV-9582) was heat treated at various temperatures and time durations. The as-cast ingot had a Martensite transition temperature or MPTT of 261 K. By varying heat treatment parameters, the transition temperature of the alloy is tunable between about 261 K and about 268.5 K, as shown in Table 1 and FIG. 4.

TABLE 1
The Martensite transition temperatures and heat treatment parameters
in a Ni₅₀Mn₃₅In₁₄Si alloy (Ni₅₀Mn₃₅In₁₄Si - batch 1).

| | | | Martensite | |
|---|---|---|---|---|
| | First heat | Second heat | transition | S_{M} |
| | treatment | treatment | temperature | (J/kg K) |
| Sample ID | step | step | (K) | at 1.5 Tesla |
| PV-9582 | None | None | 261 | |
| | (as-cast | | | |
| | condition) | | | |
| PV-9582-h21-1 | 900° C. 4 h | 700° C. 48 h | 262.5 | 22.2 |
| PV-9582-h32-1 | 900° C. 24 h | None | 263 | 42.5 |
| PV-9582-h18-1 | 900° C. 4 h | None | 265.5 | |
| PV-9582-h31-1 | 900° C. 4 h | 600° C. 48 h | 266 | |
| PV-9582-H4-1 | 800° C. 4 h | 600° C. 72 h | 267 | 20.6 |
| PV-9582-h38-1 | 900° C. 8 h | 500° C. 48 h | 268.5 | 39.1 |

### Example 2

A Ni₅₀Mn₃₅In₁₄Si alloy (Ni₅₀Mn₃₅In₁₄Si-sample SA01) was heat treated at various temperatures and time durations. The as-cast ingot had a Martensite transition temperature of 265 K. By varying heat treatment parameters, the transition temperature of the alloy is tunable between about 265 K and about 271.5 K, as shown in Table 2 and FIG. 5.

TABLE 2
The Martensite transition temperatures and heat treatment parameters
in a Ni₅₀Mn₃₅In₁₄Si alloy (Ni₅₀Mn₃₅In₁₄Si - batch 2).

| | | | Martensite | |
|---|---|---|---|---|
| | First heat | Second heat | transition | S_{M} |
| | treatment | treatment | temperature | (J/kg K) |
| Sample ID | step | step | (K) | at 1.5 Tesla |
| SA01 | None | None | 265 | |
| | (as-cast) | | | |
| SA01-h3-1 | 900° C. 4 h | 700° C. 48 h | 266 | |
| SA01-h7-1 | 900° C. 24 h | None | 267.5 | 33.1 |
| SA01-h13-1 | 900° C. 4 h | 600° C. 48 h | 269.5 | 29.1 |
| SA01-h1-1 | 800° C. 4 h | 600° C. 67 h | 270 | 33.6 |
| SA01-h11-1 | 900° C. 8 h | 500° C. 48 h | 271.5 | |

### Example 3

A Ni₅₁Mn_{33.4}In_{15.6} alloy (sample PV-9646) was heat treated at various temperatures and time durations. The as-cast ingot had a Martensite transition temperature or MPTT of 273 K. By varying heat treatment parameters, the transition temperature of the alloy is tunable between about 273 K and about 287.5 K, as shown in Table 3 and FIG. 6.

TABLE 3
The Martensite transition temperatures and heat
treatment parameters in a Ni₅₁Mn_{33.4}In_{15.6} alloy.

| | | | Martensite | |
|---|---|---|---|---|
| | First heat | Second heat | transition | S_{M} |
| | treatment | treatment | temperature | (J/kg K) |
| Sample ID | step | step | (K) | at 1.5 Tesla |
| PV-9646 | None | None | 273 | |
| | (as cast) | | | |
| PV-9646-h1 | 900° C. 24 h | None | 277.5 | 25.7 |
| PV-9646-h4 | 900° C. 8 h | 500° C. 48 h | 287.5 | 18.8 |

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A magnetic refrigerant comprising a magnetocaloric alloy material having the composition according to the formula:
A_{w}BₓC_{y}D_{z}
where:
A is Ni, Co, Cr, or a combination thereof, and 40%≦w≦56%,
B is Mn and 15%≦x≦45%,
C is In, Ga, Sn, Sb, Cu, or a combination thereof, and 9%≦y≦30%,
D is Si, Ge, As, or a combination thereof, and 0%≦z≦5%; and
w+x+y+z=100% (all in atomic percent).

2. The magnetic refrigerant of claim 1, where
A is Ni, and 45%≦w≦55%,
B is Mn, and 30%≦x≦45%,
C is In, and 9%≦y≦30%; and
D is Si, and 0.1%≦z≦5% (all in atomic percent).

3. The magnetic refrigerant of claim 1, where
A is Ni, and 45%≦w≦55%,
B is Mn, and 30%≦x≦45%, and
C is Ga, Cu, or a combination thereof, and 9%≦y≦30% with Cu being present in an amount of about 5 percent or less (all in atomic percent).

4. The magnetic refrigerant of claim 1, where
A is Ni, Co, Cr or a combination thereof, and 45%≦w≦55%,
B is Mn, and 30%≦x≦45%, and
C is In, and 9%≦y≦15% with Cu present in an amount of about 10 percent or less, and Cr present in an amount of 10 percent or less (all in atomic percent).

5. The magnetic refrigerant of claim 1, wherein the alloy has a magneto-structural phase transition temperature in the range of about 220 K to about 340 K.

6. The magnetic refrigerant of claim 1, wherein the alloy has a magneto-structural phase transition temperature in the range of about 250 K to about 316 K.

7. The magnetic refrigerant of claim 1, wherein the alloy has a magneto-structural phase transition temperature that can be modified by annealing.

8. The magnetic refrigerant of claim 1, wherein the alloy has a magneto-structural phase transition temperature that can be increased by an amount in range of greater than 0 K to about 10 K by annealing.

9. The magnetic refrigerant of claim 1, wherein the alloy has been annealed.

10. The magnetic refrigerant of claim 1, wherein the alloy has been annealed to alter the magneto-structural phase transition temperature by an amount in the range of greater than about 0 K to about 8 K.

11. A regenerator comprising the magnetic refrigerant of claim 1.

12. A refrigerator appliance, comprising:
a compartment for the storage of food items;
a first heat exchanger for the removal of heat from the compartment;
a second heat exchanger for the delivery of heat removed by the first heat exchanger to a location external of the compartment; and
a regenerator in thermal communication the first and second heat exchanger and configured for the transfer of heat between the first and second heat exchanger, said regenerator including a magnetic refrigerant comprising a magnetocaloric alloy material having the general formula:
A_{w}BₓC_{y}D_{z}
where:
A is Ni, Co, Cr, or a combination thereof, and 40%≦w≦56%,
B is Mn and 15%≦x≦45%,
C is In, Ga, Sn, Sb, Cu, or a combination thereof, and 9%≦y≦30%,
D is Si, Ge, As, or a combination thereof, and 0%≦z≦5%; and
w+x+y+z=100%.

13. The magnetic refrigerant of claim 12, wherein the alloy has been annealed.

14. The magnetic refrigerant of claim 12, wherein the alloy has been annealed and has a magneto-structural phase transition temperature in the range of about 220 K to about 340 K.

15. A magnetic refrigerant comprising a magnetocaloric alloy material prepared by a process comprising the steps of:
preparing an alloy having the general formula:
A_{w}BₓC_{y}D_{z}
where:
A is Ni, Co, Cr, or a combination thereof, and 40%≦w≦56%,
B is Mn and 15%≦x≦45%,
C is In, Ga, Sn, Sb, Cu, or a combination thereof, and 9%≦y≦30%,
D is Si, Ge, As, or a combination thereof, and 0%≦z≦5%; and
w+x+y+z=100%;
annealing the alloy in a first annealing step at a temperature in the range of about 800° C. to about 1000° C. for a first predetermined period of time;
quenching the alloy in a first quenching step;
annealing the alloy in a second annealing step at a temperature in the range of about 500° C. to about 700° C. for a second predetermined period of time; and
quenching the alloy in a second quenching step.

16. The magnetic refrigerant of claim 15, wherein the first and second quenching steps comprise placing the alloy into water, oil, or an insert gas so as to rapidly reduce the temperature of the alloy.

17. The magnetic refrigerant of claim 15, wherein the first predetermined period of time is in the range of about 4 to about 24 hours.

18. The magnetic refrigerant of claim 15, wherein the second predetermined period of time is in the range of about 24 to about 72 hours.

19. A method of preparing a magnetocaloric alloy material, comprising the steps of:
preparing an alloy having the general formula:
A_{w}BₓC_{y}D_{z}
where:
A is Ni, Co, Cr, or a combination thereof, and 40%≦w≦56%,
B is Mn and 15%≦x≦45%,
C is In, Ga, Sn, Sb, Cu, or a combination thereof, and 9%≦y≦30%,
D is Si, Ge, As, or a combination thereof, and 0%≦z≦5%; and
w+x+y+z=100%.
annealing the alloy in a first annealing step at a temperature in the range of about 800° C. to about 1000° C. for a first predetermined period of time;
quenching the alloy in a first quenching step;
annealing the alloy in a second annealing step at a temperature in the range of about 500° C. to about 700° C. for a second predetermined period of time; and
quenching the alloy in a second quenching step.

20. The method of preparing a magnetocaloric alloy material as in claim 19, further comprising the step of altering the magneto-structural phase transition temperature by an amount in the range of greater than 0 K to about 10 K.
